(19) United States
(12) Patent Application Publication
(10) Pub. No.: US 2024/0364186 A1
(43) Pub. Date: Oct. 31, 2024

(54) COOLING OF AN INTEGRATED VARIABLE-SPEED DRIVE AND MOTOR

(71) Applicant: ePropelled Inc., Lowell, MA (US)

(72) Inventors: Narotam Singh GREWAL, Sanbornton, NH (US); Nick DeSILVIO, Lowell, MA (US); Hossein TAVALLAI, Lowell, MA (US); David BAMGBOJE, Lowell, MA (US); Nabeel Ahmed SHIRAZEE, Cardiff (GB)

(73) Assignee: ePropelled Inc., Lowell, MA (US)

(21) Appl. No.: 18/309,529

(22) Filed: Apr. 28, 2023

(51) Int. Cl. H02K 9/04; H02K 5/10; H02K 9/22

(52) U.S. Cl. CPC H02K 9/04; H02K 5/10; H02K 9/227

(57) ABSTRACT

An electrical motor and drive (10) comprises a motor unit (13) having a stator (32) and a rotor (33) disposed inside a housing (29), the rotor (32) being supported inside the annular stator (33) by a shaft (30) which is rotatably mounted to the housing (29) by bearings (39). A variable speed drive unit (11) of the motor (10) comprises a plurality of electronic components (35), an elongate flow duct (19) and heatsink having elongate fins (17) which extend along the flow duct (19). A fan unit (12) is disposed between the motor and drive units (11, 13), the fan portion comprising a centrifugal fan (25) mounted on the shaft (30) and having a central air intake which faces axially towards the drive unit (11). The flow duct (19) extends to the fan intake so that the fan (25) draws air along the flow duct (19) to efficiently dissipate heat from the fins (17) and is expelled radially.

### BACKGROUND OF THE INVENTION

### 1. Field of the Invention

This invention relates to an electrical machine such as a motor having an integrated variable-speed drive and integral cooling.

### 2. Related Background Art

Electrical machines driven by a variable-speed drive are well known for applications such as pump and heating, ventilation and air-conditioning. Such assemblies can become hot during operation due to the heat generated by the motor as well as its variable-speed drive unit. The problem is exacerbated due to poor air circulation if, for example, the pump assembly is operating in a confined space.

In order to overcome the above-mentioned, it is also well known to provide integrated motor and variable-speed drive assemblies with cooling fan which is disposed adjacent the rear of the assembly in a manner similar to that of an induction motor. The electric motor comprises a motor housing, a stator, an annular rotor and a shaft. The stator and the rotor are arranged inside the motor housing, the rotor being supported inside the annular rotor by the shaft, which is rotatably to opposite ends of the housing by bearings. The cooling fan is mounted at one end of the shaft such that it rotates along with the shaft at the rear end of the assembly, the fan being of the centrifugal flow type having radially extending fan blades. The variable-speed drive unit is mounted on the outer surface of the motor housing and comprises electronic components which power and control the electric motor.

Initially, the fan directly draws air axially into the rear of the assembly. The fan then drives the air radially outwards towards a peripheral cowl which directs the air horizontally towards the motor body and the variable-speed drive unit, so as to cool both the electronics of the drive unit and the motor. Whilst this arrangement is by far the most common method of cooling, it is not effective because the air loses its momentum when it is driven radially and then horizontally. Also, the air becomes warm as it moves from one stage to the other.

WO2023012505A1 and US2015042187A1 disclose electrical machines having improved cooling arrangements, in which the electronic components and the fan are mounted inside the housing of the electrical machine. The electronic components are disposed between a vented end wall of the housing and the fan, a central airflow space or passage is defined through the vented end wall initially serves to cool the electronics before cooling the windings of the electrical machine. A problem of this arrangement is that the confined space inside the housing gets extremely hot and arrangement of the electronics within the housing means that the heat is extracted from the heatsink only by the air swirled by the fan in the central area i.e. after the air hits the fan blades. Furthermore, this arrangement is not advantageous because the electronics are not sufficiently cooled by the relatively arbitrary airflow that is created.

With the foregoing problems in mind, we have now devised an electrical motor and variable-speed drive having improved cooling.

### SUMMARY OF THE INVENTION

In accordance with the present invention, there is provided an electrical machine comprising:
a body portion having a stator and a rotor disposed inside a housing, the rotor being supported inside the stator or vice-versa by a shaft which is rotatably mounted to the housing by bearings;
a drive portion comprising a plurality of electronic components, a heatsink and a flow duct, the electronic components being electrically connected to the stator and the heatsink being disposed in the flow duct;
a fan portion disposed between the body and drive portions, the fan portion comprising a centrifugal fan mounted on the shaft and having a central air intake which faces axially towards the drive portion, wherein the flow duct of the drive portion extends to the fan intake.

The machine adopts an inline arrangement of cooling, whereby the drive portion, the fan and the body portion are all arranged in line with respect to each other. In use, cooling air is drawn directly from the surrounding environment and along the flow duct where it flows over the heatsink. The cooling air is drawn through the drive portion by the rotating centrifugal fan disposed between the drive portion and the body portion. In this manner, the air losses no momentum and the drive portion is directly cooled by the incoming ambient air.

The heatsink may comprise one or more fins which extend longitudinally of the flow duct.

The heatsink may be provided on a wall of a compartment which contains the electronic components. The compartment may be a sealed compartment which is sealed against the ingress or egress of fluids and particles.

The drive portion may comprise a plurality of heatsinks disposed in respective flow ducts which extend through the drive portion. The heatsinks may be disposed on respective sides of the compartment. In some embodiments, the heatsink may be disposed on an external wall of the drive portion and thus a cowl may be mounted to the external wall over the heatsink, so as order to form a flow duct which maximises the volume of air that will flow over the heatsink.

The flow ducts may be connected to the fan intake by a manifold, which may have a wide inlet that tapers inwardly towards the fan intake.

The fan portion may further comprise an apertured surround extending around the fan. The surround may comprise ribs which act to dissipate the heat from the fan portion.

The housing may comprise a rear end wall facing the fan portion, the rear end wall being formed of a thermally conductive material such as metal which forms a front wall of a cavity in the fan portion in which the fan is mounted. In this manner, the airflow around the fan inside the cavity acts to dissipate heat generated by the rotor and stator away, from the rear end wall of the housing.

### BRIEF DESCRIPTION OF THE DRAWINGS

An embodiment of the present invention will now be described by way of an example only with reference to the accompanying drawings, in which:

FIG. 1 is a side view of an electrical motor and drive in accordance with the present invention;

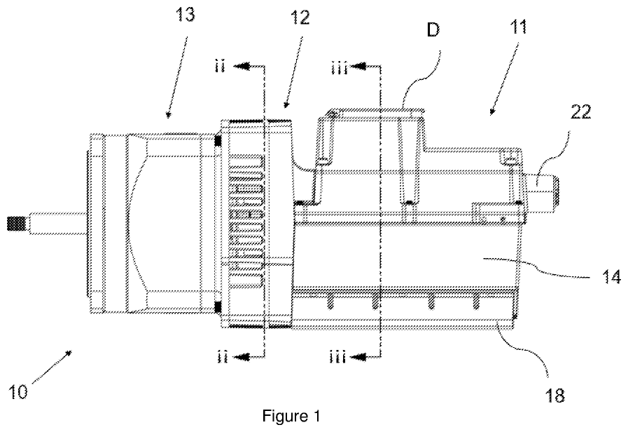

FIG. 2 is a sectional view along the line ii-ii of FIG. 1;

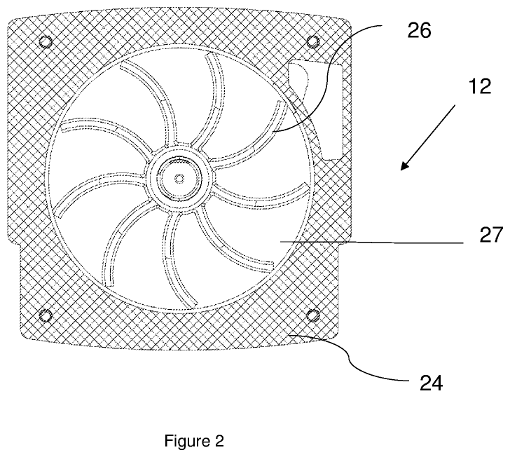

FIG. 3 is a sectional view along the line iii-iii of FIG. 1;

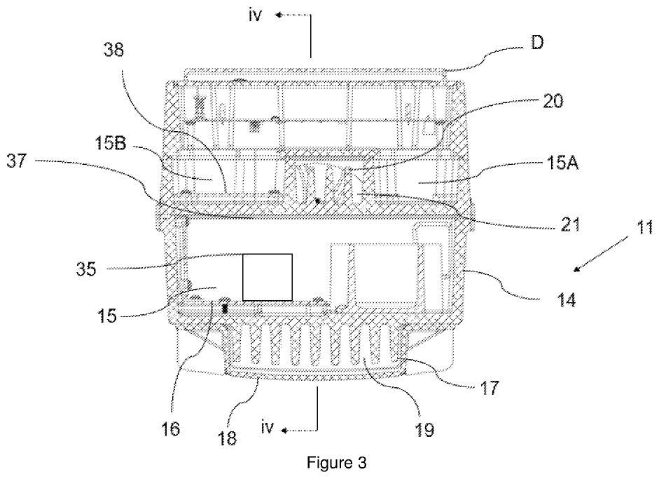

FIG. 4 is a sectional view along the iv-iv of FIG. 3; and

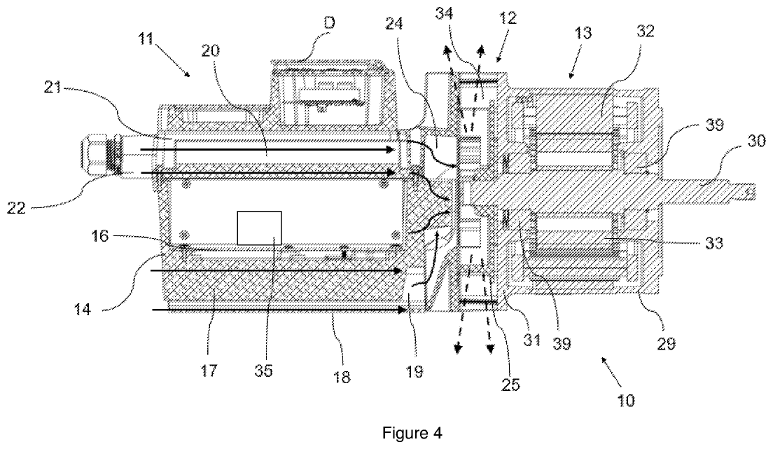

FIG. 5 is an exploded isometric view of the electrical motor of FIG. 1.

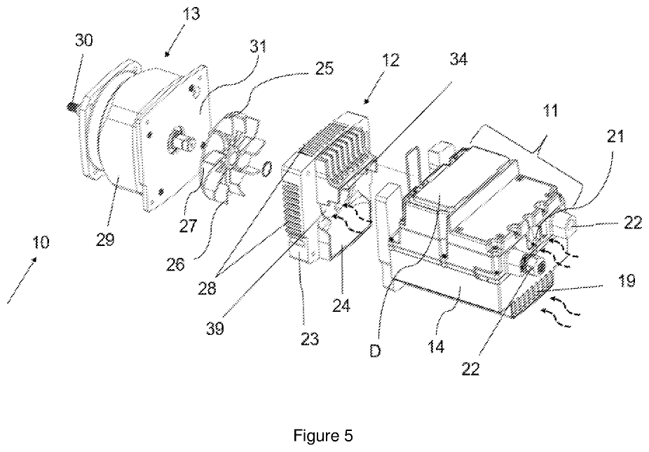

### DETAILED DESCRIPTION OF THE PREFERRED EMBODIMENT

Referring to the drawings, there is shown an electrical motor with integrated drive 10 comprising a drive unit 11, a fan unit 12 and a motor unit 13. As will be explained hereinafter the motor unit 11 is a permanent magnet brushless motor or a switched reluctance motor or a synchronous reluctance motor having a stator divided into a plurality of phase windings. As an example, the motor can also be an outer or an inner rotor or an axial flux type.

The drive unit 11 comprises electronic components e.g. 35, such as capacitors, field-effect transistors (FETs), Insulated Gate Bi-polar transistors (IGBT) or other semiconductor devices for applying a suitable drive signal to the stator.

The drive unit 11 comprises a casing or enclosure 14 formed of metal or another highly thermally conductive material. The enclosure 14 may be provided with external ribs (not shown) which help to dissipate heat into the atmosphere. The enclosure 14 comprises an internal compartment 15 in which a printed circuit board (PCB) 38 carrying some electronic components e.g. 16 is disposed. In the example shown, the compartment 15 is divided by an internal boundary wall 37 to provide upper sub-compartments 15A, 15B in which further printed circuit boards (PCBs) e.g. 38 are disposed. A display unit D is provided on the upper surface of the drive unit 11. The lower surface of the drive unit 11 comprises a plurality of depending elongate fins 17 which extend axially of the electrical motor/drive 10. An elongate channel-shaped cowl 18 is fitted to the lower surface of the drive unit 11 over the fins 17, so as to create a longitudinally extending lower flow duct 19. The upper surface of the internal boundary wall 37 is provided with a plurality of upstanding elongate fins 20 which extend axially over the electrical motor/drive 10 into an elongate upper internal flow duct 21.

The rear end wall of the drive unit 11 is provided with one or more cable glands 22 through which signal and power cables extend into the enclosure 14. The front-end wall of the drive unit 11 is connected to a fan body member 23 of the fan unit 12, the fan body member 23 being formed of a plastic, composite or metal material. The rear end face of the fan body member 23 comprises a manifold 24 having a wide mouth at its rear, which tapers inwardly and axially forwardly towards a central aperture 39. The front-end face of the fan body member 23 comprises a circular cavity 34 having an apertured side wall provided with ribs 28 which extend across aperture in a direction which extends longitudinally of the motor/drive 10.

The motor unit 13 comprises a generally cylindrical housing 29 in which an annular stator 32 is provided. The stator 32 comprises windings (not shown) which are connected to the drive/control unit 11. A stator 32 is supported inside the housing 29 and in the centre of the stator is the rotor 33 on an elongate shaft 30 which extends longitudinally of the machine/drive 10 and is rotatably mounted to opposite ends of the housing 29 by respective bearings 39. The shaft 30 has a front end which extends forwardly of the machine/drive 10 for connecting to a mechanical pump unit or other load (not shown). The rear end of the shaft 30 extends through a rear end wall 31 of the motor unit 13, the rear end wall 31 being formed of metal or another highly thermally conductive material. A centrifugal fan 25 is fitted and mechanically locked to the rear end of the shaft 30. The fan 25 comprises a circular back plate 27 which carries a plurality of radially extending curved vanes 26. The fan 25 is mounted by the shaft 30 for rotation inside the circular cavity 34 in the body member 23 of the fan unit 12. In use, when the motor unit 13 is energised, the fan 25 rotates inside the circular cavity 34 and air is drawn into the rear of the machine/drive 10. The air then flows longitudinally of the drive unit 11 along the lower and upper flow ducts 19, 21 in which the elongate fins 17, 20 are respectively disposed. The length of the fins 17, 20 create a large surface area which is cooled by the confined airflow that is channeled along the respective flow ducts 19, 21 to dissipate heat from the drive/control unit 11. This arrangement creates a high thermal gradient across the fins 17, 20 of the heatsink and allows more heat to be extracted along the length of the fin structure.

The heated air from the lower and upper flow ducts 19, 21 then passes into the mouth of the manifold 24, where it is channeled inwardly and forwardly through the aperture 39 towards the centre of the fan 25. The air increases in speed and becomes concentrated which is then drawn into the centre of the rotating centrifugal fan 25 where it is radially expelled in all directions into the surrounding environment through the ribbed apertures of the fan body member 23. The airflow around the fan 25 inside the cavity 34 also acts to dissipate heat generated by the stator 32 and rotor 33 away from the metal rear end wall 31 of the housing 29.

An electrical machine integrated with a drive in accordance with the present invention is compact and durable in design compared with known products in the market and provides efficient cooling of the drive circuit to substantially reduce the likelihood of failure by overheating.

1. An electrical machine comprising:
a body portion having a stator and a rotor disposed inside a housing, the rotor being supported inside the stator or vice-versa by a shaft which is rotatably mounted to the housing by bearings;
a drive portion comprising a plurality of electronic components, a heatsink and a flow duct, the electronic components being connected to the stator and the heatsink being disposed in the flow duct;
a fan portion disposed between the body and drive portions, the fan portion comprising a centrifugal fan mounted on the shaft and having a central air intake which faces axially towards the drive portion, wherein the flow duct of the drive portion extends to the fan intake.

2. An electrical machine as claimed in claim 1, in which the heatsink comprises one or more fins which extend longitudinally of the flow duct.

3. An electrical machine as claimed in claim 2, in which the heatsink is provided on a wall of a compartment which contains the electronic components.

4. An electrical machine as claimed in claim 3, in which the compartment is sealed against the ingress or egress of fluids and/or particles.

5. Drive portion comprises a plurality of heatsinks disposed in respective flow ducts which extend through the drive portion.

6. An electrical machine as claimed in claim 5, in which the heatsinks are disposed on respective sides of a compartment which contains the electronic components.

7. An electrical machine as claimed in claim 1, in which the heatsink is disposed on an external wall of the drive portion and a cowl is mounted to the external wall over the heatsink, so as to form said flow duct.

8. An electrical machine as claimed in claim 5, in which the flow ducts are connected to the fan intake by a manifold.

9. An electrical machine as claimed in claim 5, in which the manifold has a wide inlet that tapers inwardly and axially towards the fan intake.

10. An electrical machine as claimed in claim 1, in which the fan portion further comprises an apertured surround extending around the fan.

11. An electrical machine as claimed in claim 10, in which the surround comprises fingers which act to dissipate the heat from the fan portion.

12. An electrical machine as claimed in claim 1, in which the housing comprises a rear end wall facing the fan portion, the rear end wall being formed of a highly thermally conductive material such as metal which forms a front wall of a cavity in the fan portion in which the fan is mounted.
